(19) United States
(12) Patent Application Publication
(10) Pub. No.: US 2018/0026257 A1
(43) Pub. Date: Jan. 25, 2018

(54) NEGATIVE ACTIVE MATERIAL FOR RECHARGEABLE LITHIUM BATTERY, METHOD OF PREPARING SAME, AND RECHARGEABLE LITHIUM BATTERY INCLUDING SAME

(71) Applicant: SAMSUNG SDI CO., LTD., Yongin-si (KR)

(72) Inventors: Doori OH, Yongin-si (KR); Chul YOUM, Yongin-si (KR)

(21) Appl. No.: 15/655,258

(22) Filed: Jul. 20, 2017

(30) Foreign Application Priority Data
Jul. 21, 2016 (KR) 10-2016-0092787

(51) Int. Cl. H01M 4/133; H01M 10/0525; H01M 4/134

(52) U.S. Cl. CPC H01M 4/133; H01M 4/134; H01M 10/0525; G01N 23/2273

(57) ABSTRACT

A negative active material for a rechargeable lithium battery includes a silicon-carbon composite including a core including a crystalline carbon material, a silicon oxide, and a silicon particle and an amorphous carbon-containing coating layer on the surface of the core. An intensity ratio (Si/SiO₂) of a Si peak relative to a SiO₂ peak ranges from about 2.0 to about 3.0 as measured using an X-ray photoelectron spectroscopy for the negative active material.

### CROSS-REFERENCE TO RELATED APPLICATION

Korean Patent Application No. 10-2016-0092787, filed on Jul. 21, 2016, in the Korean Intellectual Property Office, and entitled: “Negative Active Material for Rechargeable Lithium Battery, Method of Preparing Same, and Rechargeable Lithium Battery Including Same,” is incorporated by reference herein in its entirety.

### BACKGROUND

Embodiments relate to negative active material for a rechargeable lithium battery, a method of preparing same, and a rechargeable lithium battery including the same.

### SUMMARY

Embodiments are directed to a negative active material for a rechargeable lithium battery. The negative active material includes a silicon-carbon composite including a core including a crystalline carbon material, a silicon oxide, and a silicon particle and an amorphous carbon-containing coating layer on the surface of the core. An intensity ratio (Si/SiO₂) of a Si peak relative to a SiO₂ peak ranges from about 2.0 to about 3.0 as measured using an X-ray photoelectron spectroscopy for the negative active material.

The negative active material may include about 70 atom % to about 80 atom % of silicon and about 30 atom % to about 20 atom % of oxygen as measured using energy dispersive spectroscopy.

A content of the silicon oxide may range from about 8 wt % to about 13 wt % based on 100 wt % of the silicon-carbon composite.

A maximum particle diameter (Dmax) of the silicon particles may be less than or equal to about 250 nm.

A maximum particle diameter of the silicon particles may be about 30 nm to about 250 nm.

Embodiments are also directed to a method of preparing a negative active material for a rechargeable lithium battery. The method includes mixing silicon and an antioxidant in a mixing ratio of about 9 wt % to about 11 wt % of an antioxidant relative to 100 wt % of silicon in a solvent to prepare a mixture, ball milling the mixture to prepare a silicon mixture of a silicon oxide and a silicon particle coated with the antioxidant, mixing the silicon mixture with a crystalline carbon-based material to prepare a silicon-crystalline carbon-based material mixture, adding an amorphous carbon precursor to the silicon-crystalline carbon-based material mixture, and heat-treating the resultant.

The antioxidant may be stearic acid, polyvinylpyrrolidone, or a combination thereof.

The solvent may be an alcohol.

A maximum particle diameter of the silicon particles may be less than or equal to about 250 nm.

A maximum particle diameter of the silicon particles may be about 30 nm to about 250 nm.

Embodiments are also directed to a rechargeable lithium battery including a negative electrode including the negative active material described above, a positive electrode including a positive active material, and an electrolyte.

### BRIEF DESCRIPTION OF THE DRAWINGS

Features will become apparent to those of skill in the art by describing in detail exemplary embodiments with reference to the attached drawings in which:

FIG. 1 illustrates an exploded perspective view showing a rechargeable lithium battery.

FIG. 2 illustrates a graph showing a size of a silicon particle in a negative active material according to Example 1.

FIG. 3 illustrates a graph showing X-ray photoelectron spectroscopy (XPS) results of negative active materials according to Example 1 and Comparative Example 1.

FIG. 4 illustrates a graph showing dQ/dV of half-cells respectively using the negative active materials according to Example 1 and Comparative Example 1.

FIG. 5 illustrates a graph showing potentials of the half-cells respectively using the negative active materials of Example 1 and Comparative Example 1 depending on a depth of discharge.

FIG. 6 illustrates a graph showing charge and discharge characteristics of the half-cells respectively using the negative active materials of Example 1 and Comparative Examples 1 and 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

A negative active material for a rechargeable lithium battery according to an embodiment includes a silicon-carbon composite including a core including a crystalline carbon material, a silicon oxide, and a silicon particle and an amorphous carbon-containing coating layer on the surface of the core.

An intensity ratio (Si/SiO₂) of a Si peak relative to a SiO₂ peak ranges from about 2.0 to about 3.0 when measured using an X-ray photoelectron spectroscopy (XPS) for the negative active material. This peak intensity ratio of the Si peak relative to the SiO₂ peak indicates a height ratio thereof. When the intensity ratio (Si/SiO₂) of the Si peak relative to the SiO₂ peak is less than about 2.0 or greater than about 3.0, a negative electrode may expand according to charge and discharge, and capacity and charge and discharge efficiency of the negative active material may also be deteriorated.

The negative active material may include about 70 atom % to about 80 atom % of silicon and about 30 atom % to about 20 atom % of oxygen when measured using energy dispersive spectroscopy. When the silicon and the oxygen are included in the negative active material include within the atom % ranges, efficiency and capacity characteristics may be improved.

The silicon oxide may be included in an amount of about 8 wt % to about 13 wt % based on 100 wt % of the total weight of the negative active material. When the silicon oxide is included within the range, cycle-life characteristics and efficiency may be further improved.

A maximum particle diameter (Dmax) of the silicon particle may be less than or equal to about 250 nm, for example, about 30 nm to about 250 nm. The term “maximum particle diameter (Dmax)” indicates the largest particle diameter in a silicon particle distribution. The particle diameter may be measured by using a laser diffraction-type particle distribution-measuring device. When the silicon particle has a maximum particle diameter (Dmax) of greater than about 250 nm, capacity and charge and discharge efficiency of the negative active material may be deteriorated.

The silicon particle may have a maximum particle diameter (Dmax) of about 30 nm to about 250 nm. According to an embodiment, the silicon particle may have an average particle diameter (D50) of about 50 nm to about 100 nm but need not to be limited thereto if the maximum particle diameter (Dmax) is less than or equal to about 250 nm. The average particle diameter (D50) may be obtained from a volume reference particle distribution. The term “D50” refers to a particle size when a particle volume % corresponds to 50% out of the entire particles.

The negative active material having the composition as described herein may be prepared in the following method.

Silicon and an antioxidant may be mixed in a solvent to prepare a mixture. The antioxidant may be mixed in an amount of about 9 wt % to about 11 wt % or about 9.9 wt % to about 10.1 wt % based on 100 wt % of the silicon. When the antioxidant is used within the ranges, the mixture may effectively suppress oxidization of the silicon during a subsequent ball milling process and thus may reduce the amount of a silicon oxide in a final negative active material. In this way, the amount of the silicon oxide having small capacity may be reduced, and the capacity of the final negative active material may be increased.

When the antioxidant is included within the range, oxidization of the silicon may be sufficiently suppressed. The oxidization suppression effect may be sufficiently obtained by using about 11 wt % of the antioxidant at most based on 100 wt % of the silicon, but the oxidization suppression effect may not be increased even though the antioxidant is used greater than the amount.

The mixing process may require adjustment of a mixing ratio of the silicon and the antioxidant, but the amount of the solvent may not need adjustment as long as the silicon particle and the antioxidant are dispersed therein.

The antioxidant may be stearic acid, polyvinylpyrrolidone, or a combination thereof.

The solvent may be alcohol, for example, ethanol, methanol, propanol, or a combination thereof.

Subsequently, the mixture may be ball-milled. The ball milling process may oxidize a part of the silicon particle and form a silicon oxide. For example, the partly-oxidized silicon oxide may be present inside the silicon particle. In addition, the silicon particle may be coated with the antioxidant on the surface thereof.

The ball milling process may be performed until the silicon particle coated with the antioxidant has a maximum particle diameter (Dmax) of less than or equal to about 250 nm. In some implementations, a maximum particle diameter (Dmax) may range from about 30 nm to about 250 nm. The ball milling process may be performed by using a general ball such as a zirconia ball, an alumina ball, or the like. The silicon particle may maintain a maximum particle diameter (Dmax) of less than or equal to about 250 nm in the final negative active material, since the maximum particle diameter (Dmax) is not changed in subsequent processes.

The obtained silicon mixture of the silicon oxide and the silicon particle coated with an antioxidant may be mixed with a crystalline carbon-based material to prepare a silicon-crystalline carbon-based material mixture.

The crystalline carbon-based material may be natural graphite, artificial graphite, or a combination thereof.

The silicon mixture and the crystalline carbon-based material may be mixed in a ratio appropriately adjusted depending on a desired product. In an embodiment, the silicon mixture and the crystalline carbon-based material may be mixed in a weight ratio of about 1:4 to about 1.5:3.5.

Subsequently, an amorphous carbon precursor may be added to the silicon-crystalline carbon-based material mixture. The amorphous carbon precursor may be coal pitch, mesophase pitch, petroleum pitch, charcoal-based oil, petroleum-based heavy oil, or a polymer resin such as a phenol resin, a furan resin, a polyimide resin, or the like.

The silicon-crystalline carbon-based material mixture and the amorphous carbon precursor may be mixed in a weight ratio of about 8:2 to about 7.99:2.01. When the silicon-crystalline carbon-based material mixture and the amorphous carbon precursor are mixed within the range, cycle-life characteristics may be appropriately maintained, and capacity may be improved.

A product obtained therefrom is heat-treated to prepare a negative active material for a rechargeable lithium battery. The heat-treating may be performed at about 950° C. to about 960° C. for about 16 hours to about 17 hours.

The heat-treating may decompose and remove the antioxidant coated on the surface of the silicon particle. In addition, the amorphous carbon precursor may be converted into an amorphous carbon. Thus, an amorphous carbon-containing coating layer may be formed on the surface of the core including the silicon oxide, the silicon particle, and the crystalline carbon-based material.

Another embodiment provides a rechargeable lithium battery including a positive electrode including a positive active material, a negative electrode including the negative active material, and an electrolyte.

In the positive active material layer, the positive active material may be a compound (for example, a lithiated intercalation compound) capable of intercalating and deintercalating lithium. For example, the positive active material may include one or more composite oxides of a metal selected from cobalt, manganese, nickel, and a combination thereof, and lithium. For example, the compounds represented by one of the following chemical formulae may be used. LiₐA_{1-b}X_{b}D₂ (0.90≦a≦1.8, 0≦b≦0.5); LiₐA_{1-b}X_{b}O_{2-c}D_{c} (0.90≦a≦1.8, 0≦b≦0.5, 0≦c≦0.05); LiₐE_{1-b}X_{b}O_{2-c}D_{c} (0.90≦a≦1.8, 0≦b≦0.5, 0≦c≦0.05); LiₐE_{2-b}X_{b}O_{4-c}D_{c} (0.90≦a≦1.8, 0≦b≦0.5, 0≦c≦0.05); LiₐNi_{1-b-c}Co_{b}X_{c}D_{α} (0.90≦a≦1.8, 0≦b≦0.5, 0≦c≦0.5, 0<α<2); LiₐNi_{1-b-c} Co_{b}X_{c}O_{2-α}T₂, (0.90≦a≦1.8, 0≦b≦0.5, 0≦c≦0.05, 0<α<2); LiₐNi_{1-b-c}Co_{b}X_{c}D_{2-α}T₂ (0.90≦a≦1.8, 0≦b≦0.5, 0≦c≦0.05, 0<α<2); LiₐNi_{1-b-c}Mn_{b}X_{c}D_{α} (0.90≦a≦1.8, 0≦b≦0.5, 0≦c≦0.05, 0<α≦2); LiₐNi_{1-b-c}Mn_{b}X_{c}O_{2-α}T_{α} (0.90≦a≦1.8, 0≦b≦0.5, 0≦c≦0.05, 0<α<2); LiₐNi_{1-b-c}Mn_{b}X_{c}O_{2-α}T₂ (0.90≦a≦1.8, 0≦b≦0.5, 0≦c≦0.05, 0<α<2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}GₑO₂ (0.90≦a≦1.8, 0≦b≦0.9, 0≦c≦0.5, 0≦d≦0.5, 0.001≦e≦0.1); LiₐNiG_{b}O₂ (0.90≦a≦1.8, 0.001≦b≦0.1) LiₐCoG_{b}O₂ (0.90≦a≦1.8, 0.001≦b≦0.1); LiₐMn_{1-b}G_{b}O₂ (0.90≦a≦1.8, 0.001≦b≦0.1); LiₐMn₂G_{b}O₄ (0.90≦a≦1.8, 0.001≦b≦0.1); LiₐMn_{1-g}G_{b}PO₄ (0.90≦a≦1.8, 0≦g≦0.5); QO₂; QS₂; LiQS₂; V₂O₅; LiV₂O₅; LiZO₂; LiNiVO₄; Li_{(3-f)}J₂(PO₄)₃ (0≦f≦2); Li_{(3-f)}Fe₂(PO₄)₃ (0≦f≦2); and LiₐFePO₄ (0.90≦a≦1.8).

In the above chemical formulae, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive active material by using these elements in the compound. For example, the method may include a suitable coating method such as spray coating, dipping, or the like.

In the positive electrode, a content of the positive active material may be about 90 wt % to about 98 wt % based on the total weight of the positive active material layer.

In an embodiment, the positive active material layer may include a binder and a conductive material. The binder and the conductive material may be included in an amount of about 1 wt % to about 5 wt %, respectively based on the total amount of the positive active material layer.

The binder improves binding properties of positive active material particles with one another and with a current collector. Examples thereof may be polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like.

The conductive material may be included to provide electrode conductivity. A suitable electrically conductive material that does not cause a chemical change may be used as the conductive material. Examples of the conductive material include a carbon-based material such as natural graphite, artificial graphite, carbon black, acetylene black, ketjen black, a carbon fiber or the like, a metal-based material of a metal powder or a metal fiber including copper, nickel, aluminum, silver, and the like, a conductive polymer such as a polyphenylene derivative, or a mixture thereof.

The current collector may include Al, as an example.

The negative electrode may include a current collector and a negative active material layer including the negative active material formed on the current collector.

In the negative active material layer, the negative active material may be included in an amount of about 95 wt % to about 99 wt % based on the total weight of the negative active material layer.

In an embodiment, the negative active material layer may include a binder, and optionally, a conductive material. The negative active material layer may include about 1 wt % to about 5 wt % of a binder based on the total weight of the negative active material layer. When the negative active material layer includes a conductive material, the negative active material layer may include about 90 wt % to about 98 wt % of the negative active material, about 1 wt % to about 5 wt % of the binder, and about 1 wt % to about 5 wt % of the conductive material.

The binder may improve binding properties of negative active material particles with one another and with a current collector. The binder may include a non-aqueous binder, an aqueous binder, or a combination thereof.

The non-aqueous binder may include polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

The aqueous binder may be a styrene-butadiene rubber, an acrylated styrene-butadiene rubber (SBR), an acrylonitrile-butadiene rubber, an acrylic rubber, a butyl rubber, a fluorine rubber, an ethylenepropylene copolymer, polyepichlorohydrin, polyphosphazene, polyacrylonitrile, polystyrene, an ethylenepropylenediene copolymer, polyvinylpyridine, chlorosulfonated polyethylene, latex, a polyester resin, an acrylic resin, a phenolic resin, an epoxy resin, polyvinyl alcohol, or a combination thereof.

When the aqueous binder is used as the negative electrode binder, a cellulose-based compound may be further used to provide viscosity as a thickener. The cellulose-based compound may include one or more of carboxymethyl cellulose, hydroxypropylmethyl cellulose, methyl cellulose, or alkali metal salts thereof. The alkali metal may be Na, K, or Li. Such a thickener may be included in an amount of about 0.1 to about 3 parts by weight based on 100 parts by weight of the negative active material.

The conductive material may be included to provide electrode conductivity. A suitable electrically conductive material that does not cause a chemical change may be used as the conductive material. Examples of the conductive material include a carbon-based material such as natural graphite, artificial graphite, carbon black, acetylene black, ketjen black, a carbon fiber or the like, a metal-based material of a metal powder or a metal fiber including copper, nickel, aluminum, silver, or the like, a conductive polymer such as a polyphenylene derivative, or a mixture thereof.

The current collector may include a copper foil, a nickel foil, a stainless steel foil, a titanium foil, a nickel foam, a copper foam, a polymer substrate coated with a conductive metal, or a combination thereof.

The electrolyte may include a non-aqueous organic solvent and a lithium salt.

The non-aqueous organic solvent may serve as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester-based solvent may include methyl acetate, ethyl acetate, n-propyl acetate, dimethylacetate, methylpropionate, ethylpropionate, decanolide, mevalonolactone, caprolactone, or the like. The ether-based solvent may include dibutyl ether, tetraglyme, diglyme, dimethoxyethane, 2-methyltetrahydrofuran, tetrahydrofuran, or the like. The ketone-based solvent includes cyclohexanone, or the like. The alcohol-based solvent include ethyl alcohol, isopropyl alcohol, or the like. Examples of the aprotic solvent include nitriles such as R—CN (where R is a C2 to C20 linear, branched, or cyclic hydrocarbon, and may include a double bond, an aromatic ring, or an ether bond), amides such as dimethylformamide, dioxolanes such as 1,3-dioxolane, sulfolanes, or the like.

The organic solvent may be used alone or in a mixture. When the organic solvent is used in a mixture, the mixture ratio may be controlled in accordance with a desirable battery performance.

The carbonate-based solvent may include a mixture with a cyclic carbonate and a linear carbonate. The cyclic carbonate and linear carbonate may be mixed together in a volume ratio of about 1:1 to about 1:9. When the mixture is used as an electrolyte, the electrolyte may have enhanced performance.

The organic solvent may further include an aromatic hydrocarbon-based solvent as well as the carbonate-based solvent. The carbonate-based solvent and aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 1.

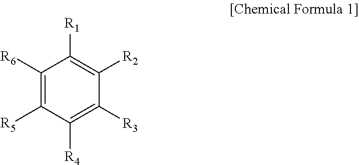

In Chemical Formula 1, R₁ to R₆ are the same or different and are selected from hydrogen, a halogen, a C1 to C10 alkyl group, a haloalkyl group, and a combination thereof.

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The electrolyte may further include an additive of vinylene carbonate, an ethylene carbonate-based compound represented by Chemical Formula 2, or propanesultone to improve cycle life.

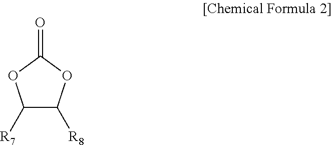

In Chemical Formula 2, R₇ and R₈ are the same or different and may be each independently hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group, and R₇ and R₈ are not simultaneously hydrogen.

Examples of the ethylene carbonate-based compound include difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle life may be flexibly used within an appropriate range.

The lithium salt dissolved in an organic solvent supplies a battery with lithium ions, basically operates the rechargeable lithium battery, and improves transportation of the lithium ions between positive and negative electrodes. Examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers, for example integers of 1 to 20), LiCl, LiI, and LiB(C₂O₄)₂ (lithium bis(oxalato) borate; LiBOB). A concentration of the lithium salt may range from about 0.1 M to about 2.0 M. When the lithium salt is included at the above concentration range, an electrolyte may have excellent performance and lithium ion mobility due to optimal electrolyte conductivity and viscosity.

The rechargeable lithium battery may further include a separator between the negative electrode and the positive electrode, depending on a kind of the battery. Examples of a suitable separator material include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

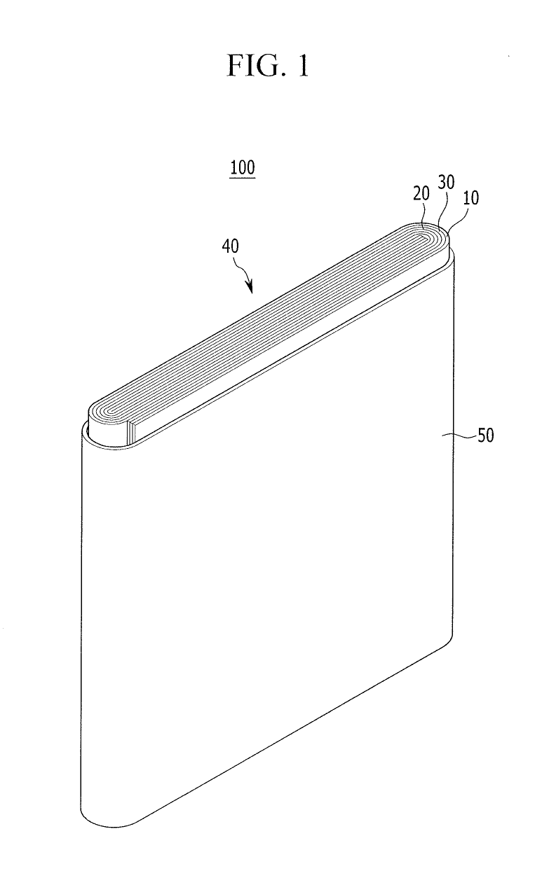

FIG. 1 illustrates an exploded perspective view showing a rechargeable lithium battery according to an embodiment. The rechargeable lithium battery according to an embodiment is illustrated as a prismatic battery. In other implementations, the rechargeable lithium battery may have various shapes. For example, the rechargeable lithium battery may be a cylindrical battery, a pouch battery, or the like.

Referring to FIG. 1, a rechargeable lithium battery 100 according to an embodiment includes an electrode assembly 40 manufactured by winding a separator 30 interposed between a positive electrode 10 and a negative electrode 20, and a case 50 housing the electrode assembly 40. An electrolyte may be impregnated in the positive electrode 10, the negative electrode 20, and the separator 30, and the case 50 may be sealed.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

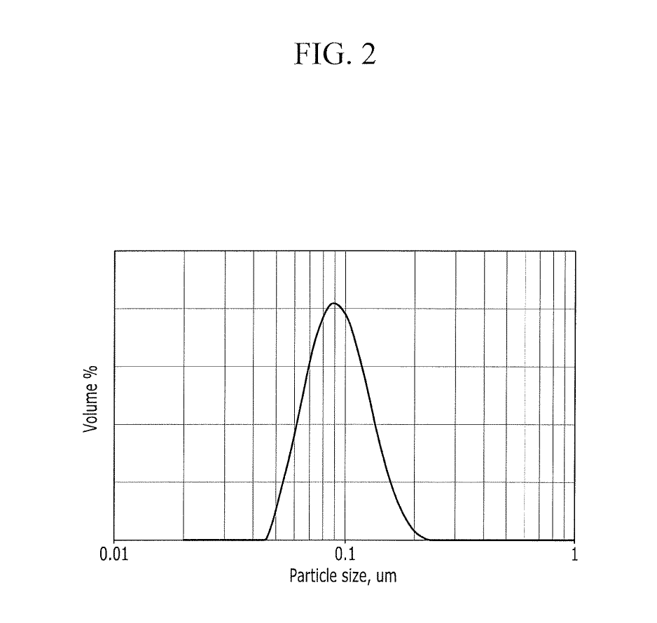

Silicon particles and stearic acid were mixed in an ethanol solvent to prepare a mixture. Herein, 10 wt % of the stearic acid was mixed based on 100 wt % of the silicon particles. This mixture was ball-milled by using a zirconia ball. The ball milling provided a silicon oxide and the silicon particles coated with the stearic acid. The diameter of the silicon particles after the ball-milling was measured by using a laser diffraction-type particle diameter distribution-measuring device (MS2000, Malvern Instruments), and the results are shown in FIG. 2, in which the x-axis is a log scale. Referring to the results shown in FIG. 2, the silicon particles had a maximum particle diameter (Dmax) of about 250 nm.

The obtained mixture of the silicon oxide and the silicon particles coated with the stearic acid was mixed with natural graphite in a weight ratio of 1:4 to prepare a silicon-crystalline carbon-based material mixture.

Subsequently, coal pitch was added to the silicon-crystalline carbon-based material mixture and then mixed therewith. The silicon-crystalline carbon-based material mixture and the coal pitch were mixed in a weight ratio of 8:2.

The mixture was heat-treated at 950° C. for 16 hours to manufacture a negative active material including a silicon-carbon composite including natural graphite, the silicon oxide, and the silicon particles and an amorphous carbon-containing coating layer on the surface of the silicon-carbon composite.

### Comparative Example 1

A negative active material was manufactured according to the same method as Example 1 except for using 1 wt % of the stearic acid based on 100 wt % of the silicon particles.

### Comparative Example 2

A negative active material was manufactured according to the same method as Example 1 except for using 5 wt % of the stearic acid based on 100 wt % of the silicon particles.

XPS Analysis

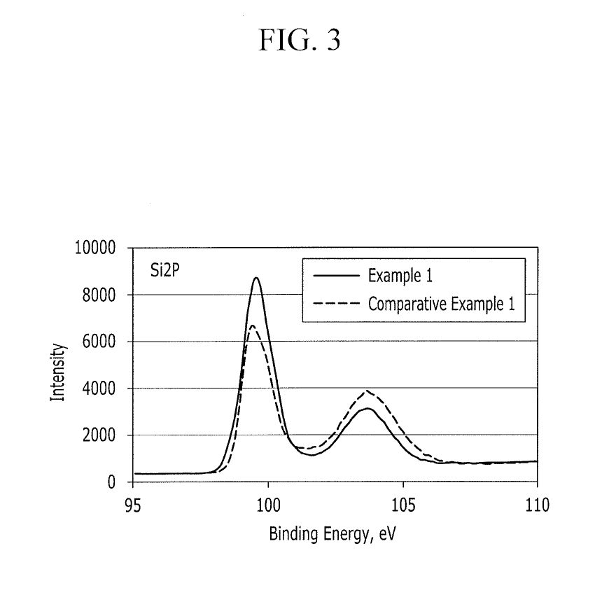

Binding energy of the negative active materials according to Example 1 and Comparative Example 1 was measured by using X-ray photoelectron spectroscopy (XPS), and the results are shown in FIG. 3. The binding energy values corresponding to Si and SiO₂ among the results are shown in Table 1.

TABLE 1

| | Si (99.4 eV) | SiO₂ (103.5 eV) | Si/SiO₂ |
|---|---|---|---|
| Example 1 | 8714 | 3077 | 2.8 |
| Comparative Example 1 | 6674 | 3882 | 1.7 |

Referring to the results of FIG. 3 and Table 1, the negative active material of Example 1 showed a higher Si/SiO₂ intensity ratio, that is, a higher Si peak intensity/SiO₂ peak intensity than the negative active material of Comparative Example 1. The reason is that the negative active material of Example 1 included silicon oxide in a lesser amount than that of Comparative Example 1 and resultantly, showed improved capacity and efficiency.

EDS Analysis

The negative active materials of Example 1 and Comparative Example 1 were analyzed with EDS to measure each atom % of Si and O. The results are shown in Table 2.

TABLE 2

| | Si atom % | O atom % |
|---|---|---|
| Example 1 | 73.56 | 26.44 |
| Comparative Example 1 | 66.74 | 33.26 |

As shown in Table 2, the negative active material of Example 1 included an increased Si atom % but a decreased 0 atom % compared with the negative active material of Comparative Example 1. This result indicates that the negative active material of Example 1 was well suppressed from an oxidization during the manufacturing process.

In addition, the content of SiO₂ included in the negative active material was calculated from the result, as shown in Table 3.

TABLE 3

| | Content of SiO₂ (wt %) |
|---|---|
| Example 1 | 11.2 |
| Comparative Example 1 | 15.5 |

As shown in Table 3, the negative active material of Example 1 included SiO₂ in a lower content than that of Comparative Example 1. This result indicates that the negative active material of Example 1 would be expected to improve battery efficiency.

Measurement of dQ/dV (Differential Capacity)

97.5 wt % of each negative active material of Example 1 and Comparative Example 1, 1.5 wt % of a styrene butadiene rubber binder, and 1 wt % of carboxymethyl cellulose were mixed in water as a solvent to prepare negative active material slurry, and the slurry was coated on a copper foil and then, dried and compressed through a common process to manufacture a negative electrode.

The negative electrode was used to manufacture a coin-type half-cell. Herein, lithium metal was used as a counter electrode, and an electrolyte was prepared by dissolving 1.5 M LiPF₆ in a mixed solvent of ethylene carbonate, ethyl methyl carbonate, and dimethyl carbonate (2:1:7 of a volume ratio).

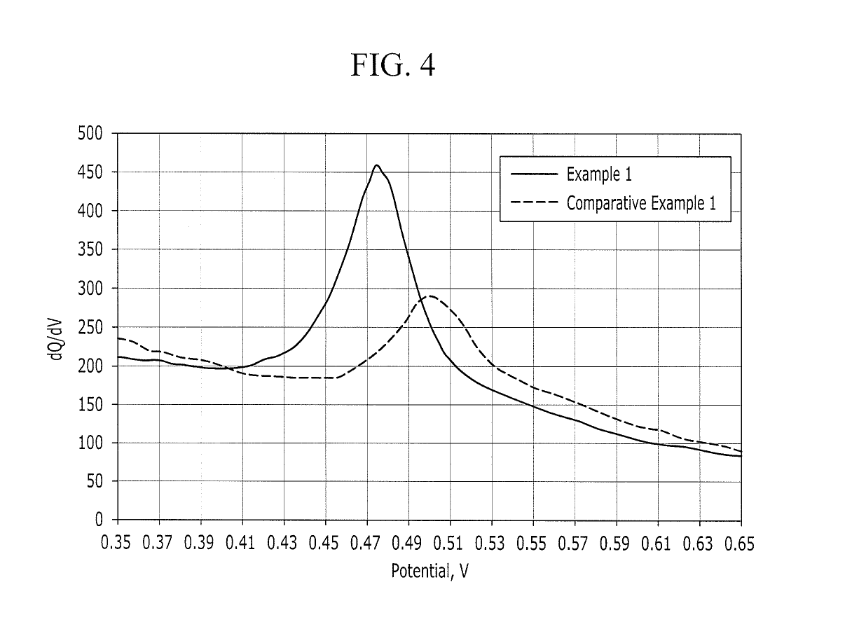

The half-cell was once charged and discharged at 0.2 C, and then, its dQ/dV was measured, and the results are shown in FIG. 4. As shown in FIG. 4, the negative active material of Example 1 showed a peak around 0.47 V, while the negative active material of Comparative Example 1 showed a peak around 0.5 V. In FIG. 4, the peak around 0.47 V was derived from Si discharge, and the peak around 0.5 V was derived from Si discharge. As shown in FIG. 4, the peak obtained from the negative active material according to Example 1 showed a high slope and thus high crystalline compared with the negative active material of Comparative Example 1, and accordingly, this result shows that the Si crystalline state was changed.

In addition, a Si peak voltage was also measured during the dQ/dV measurement, and the results are shown in Table 4.

TABLE 4

| | Si peak voltage (mV) |
|---|---|
| Example 1 | 474 |
| Comparative Example 1 | 500 |

The Si peak voltage indicates a point where a discharge curve has a changed slope, and thus a lower Si peak voltage indicates higher crystalline. Accordingly, referring to the results of Table 4, the negative active material of Example 1 showed higher crystalline than that of Comparative Example 1.

Measurement of Depth of Discharge

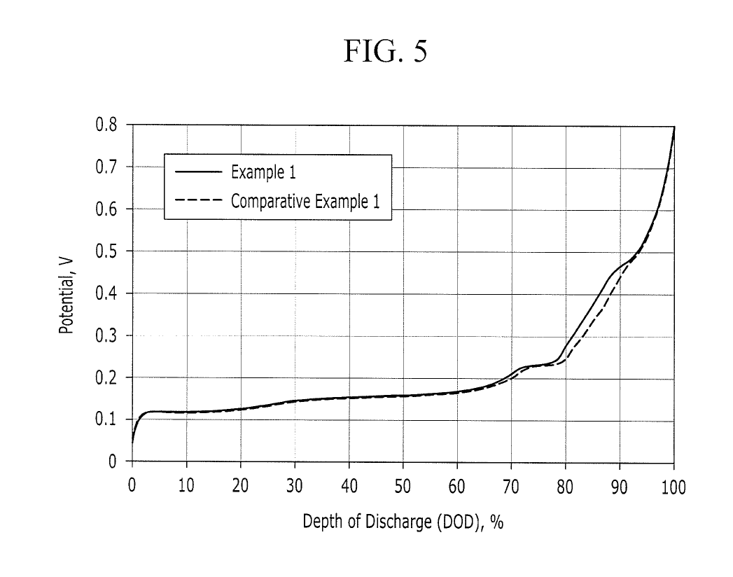

The half-cells used in the dQ/dV experiment were charged and discharged at 0.2 C, and then, potentials were measured until a depth of discharge became 0% to 100%, and the results are shown in FIG. 5. As shown in FIG. 5, the half-cell including the negative active material of Example 1 showed a higher potential at about 65% to 90% of a depth of discharge than the half-cell using the negative active material of Comparative Example 1. The reason is that the negative active material of Example 1 showed higher crystalline than the negative active material of Comparative Example 1.

Charge and Discharge Characteristics

97.5 wt % of each negative active material according to Example 1 and Comparative Examples 1 and 2, 1.5 wt % of a styrene-butadiene rubber binder, and 1 wt % of carboxymethyl cellulose were mixed to prepare negative active material slurry, and the slurry was coated on a copper foil and then, dried and compressed to respectively manufacture negative electrodes.

The negative electrodes were respectively used to manufacture coin-type half-cells. Herein, lithium metal was used as a counter electrode, and an electrolyte was prepared by dissolving 1.5 M LiPF₆ in a mixed solvent (2:1:7 volume ratio of ethylene carbonate, ethyl methyl carbonate, and dimethyl carbonate).

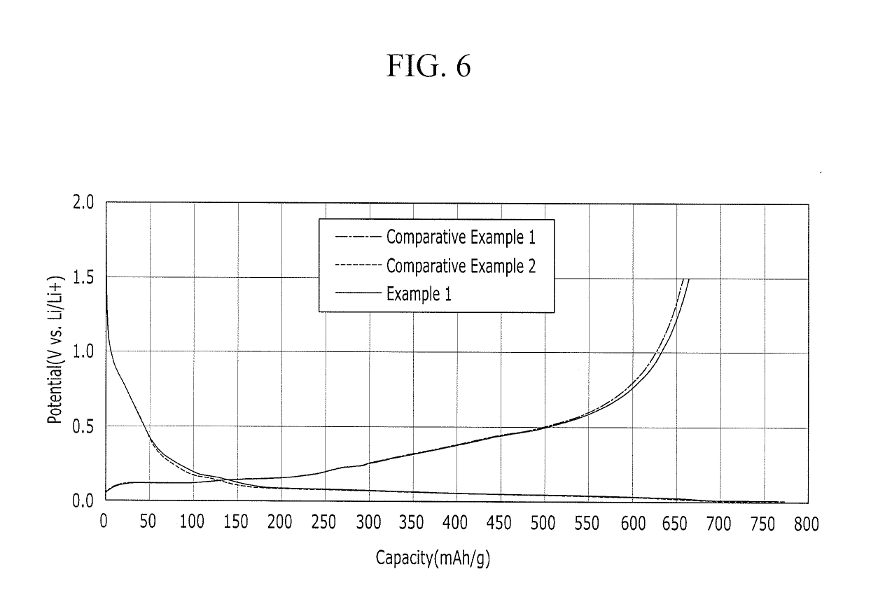

The half-cells were charged under a condition of a 0.1 C and 0.1 V constant current-constant voltage and a 0.01 C cut-off and discharged under a condition of a 0.1 C constant current and a 1.5 V cut-off, and charge and discharge characteristics were measured. The results are shown in FIG. 6. In addition, the charge and discharge capacity and charge and discharge efficiency are shown in Table 5.

As shown in FIG. 6, the half cells including the negative active material of Example 1 showed better charge and discharge characteristics than the half cells of Comparative Examples 1 and 2.

TABLE 5

| | | | Charge |
|---|---|---|---|
| | | Discharge | and |
| | Charge capacity | capacity at the | discharge |
| | at the first cycle | first cycle | efficiency |
| | (mAh/g) | (mAh/g) | (%) |
| Comparative Example 1 | 772.45 | 657.71 | 85.15 |
| Comparative Example 2 | 768.62 | 663.43 | 86.31 |
| Example 1 | 764.07 | 664.30 | 86.94 |

As shown in Table 5, the half cells including the negative active material of Example 1 showed excellent charge and discharge efficiency compared with the half cells of Comparative Examples 1 and 2.

By way of summation and review, a rechargeable lithium battery may be long used as well as have a high driving voltage and energy density and thus satisfy complex requirements according to diversification and complication of a device. An effort to further develop a conventional technology of a rechargeable lithium battery and more widely apply it to power storage and the like as well as an electric vehicle has been actively made all over the world. In addition, a high-capacity rechargeable lithium battery has been highly demanded and thus actively researched. However, there is a limit in increasing capacity of a rechargeable lithium battery. Recently, various researches on overcoming the limit of increasing capacity of the rechargeable lithium battery has been made by reducing charge time through a rapid charge.

Embodiment provide a negative active material for a rechargeable lithium battery having improved discharge capacity and efficiency.

Embodiments provide a method of preparing the negative active material.

Embodiment provide a rechargeable lithium battery including the negative active material.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A negative active material for a rechargeable lithium battery, the negative active material comprising:
a silicon-carbon composite including a core including a crystalline carbon material, a silicon oxide, and a silicon particle, and an amorphous carbon-containing coating layer on the surface of the core,
wherein an intensity ratio (Si/SiO₂) of a Si peak relative to a SiO₂ peak ranges from about 2.0 to about 3.0 as measured using an X-ray photoelectron spectroscopy for the negative active material.

2. The negative active material as claimed in claim 1, wherein the negative active material includes about 70 atom % to about 80 atom % of silicon and about 30 atom % to about 20 atom % of oxygen as measured using energy dispersive spectroscopy.

3. The negative active material as claimed in claim 1, wherein a content of the silicon oxide ranges from about 8 wt % to about 13 wt % based on 100 wt % of the silicon-carbon composite.

4. The negative active material as claimed in claim 1, wherein a maximum particle diameter of the silicon particle is less than or equal to about 250 nm.

5. The negative active material as claimed in claim 1, wherein a maximum particle diameter of the silicon particle is about 30 nm to about 250 nm.

6. A method of preparing a negative active material for a rechargeable lithium battery, the method comprising:
mixing silicon and the antioxidant in a mixing ratio of about 9 wt % to about 11 wt % of an antioxidant relative to 100 wt % of silicon in a solvent to prepare a mixture;
ball milling the mixture to prepare a silicon mixture of a silicon oxide and a silicon particle coated with the antioxidant;
mixing the silicon mixture with a crystalline carbon-based material to prepare a silicon-crystalline carbon-based material mixture;
adding an amorphous carbon precursor to the silicon-crystalline carbon-based material mixture, and
heat-treating the resultant.

7. The method as claimed in claim 6, wherein the antioxidant is stearic acid, polyvinylpyrrolidone, or a combination thereof.

8. The method as claimed in claim 6, wherein the solvent is an alcohol.

9. The method as claimed in claim 6, wherein a maximum particle diameter of the silicon particle is less than or equal to about 250 nm.

10. The method as claimed in claim 6, wherein a maximum particle diameter of the silicon particle is about 30 nm to about 250 nm.

11. A rechargeable lithium battery, comprising:
a negative electrode including the negative active material according as claimed in claim 1;
a positive electrode including a positive active material; and
an electrolyte.
